(19) United States
(12) Patent Application Publication
(10) Pub. No.: US 2018/0025644 A1
(43) Pub. Date: Jan. 25, 2018

(54) METHOD AND APPARATUS FOR MONITORING MARINE TRAFFIC

(71) Applicant: MOKPO NATIONAL MARITIME UNIVERSITY INDUSTRY-ACADEMIC CORPORATION FOUNDATION, Mokpo-si (KR)

(72) Inventors: Jung Sik JEONG, Jeollanam-do (KR); Joo Sung KIM, Seoul (KR)

(73) Assignee: MOKPO NATIONAL MARITIME UNIVERSITY INDUSTRY-ACADEMIC CORPORATION FOUNDATION, Mokpo-si (KR)

(21) Appl. No.: 15/655,996

(22) Filed: Jul. 21, 2017

(30) Foreign Application Priority Data
Jul. 22, 2016 (KR) 10-2016-0093072

(51) Int. Cl. G08G 1/16

(52) U.S. Cl. CPC G08G 1/166

(57) ABSTRACT

The present disclosure in some embodiments relates to a method and an apparatus for monitoring a marine traffic, which learn navigation data of a plurality of ships sailing over an area to be monitored to calculate standard navigation data models for respective navigation sections, and monitor the state of navigation of the ship to be monitored based on the calculated standard navigation data models, and thereby provide an accurate and objective marine traffic monitoring.

### CROSS-REFERENCE TO RELATED APPLICATIONS

The present application is based on, and claims priority from, Korean Patent Application Number 10-2016-0093072, filed Jul. 22, 2016, the disclosure of which is incorporated by reference herein in its entirety.

### TECHNICAL FIELD

The present disclosure in some embodiments relates to a method and an apparatus for monitoring a marine traffic.

### BACKGROUND

The statements in this section merely provide background information related to the present disclosure and do not necessarily constitute prior art.

A ship straying away from her planned route may cause a stranded ship or collision with port facilities, resulting in human casualties and property damage. To prevent such calamities, a vessel traffic service (VTS) center takes control of constantly monitoring the location, speed and course of the ship.

To determine whether or not the ship operates normally, conventional VTS operating methods take a trained VTS operator (VTSO) for carrying out navigation monitoring and situation prediction. In other words, the performance of the operator is crucial for safe navigation of ships. Meanwhile, the operator is susceptible to frequent work overload from monitoring a large number of ships operating in predetermined VTS areas at the same time. In this case, a decline in the operator's judgment may consequently deteriorate the accuracy of the navigation monitoring and predicting the traffic situation. In addition, with the conventional VTS operating method where monitoring of the ship navigation and predicting of the situation are dependent on the experience and intuition of theoperator, a limitation does persist that a operator may have such a job skill level to lead to an inappropriate judgment of the traffic situation.

In order to tackle this issue, an intelligent navigation state discrimination system has been proposed to automatically identify the navigational state of a ship by utilizing the cumulative shift amount of the ship and the cumulative amount of altering the ship's course. However, monitoring the navigation using such an intelligent navigation state discrimination system has a limitation that the method cannot detect a deviation from the intended course and cannot predict the traffic situation because it is performed based on the accumulated data up to the current navigation data presented by the ship. In addition, the intelligent navigation state discrimination system as used for location prediction of a ship cannot reflect the ship's changes in location, speed and course along the ship's voyage in the location prediction because the process is performed based on the current location, speed and course of the ship.

### SUMMARY

In accordance with some embodiments, the present disclosure provides an apparatus for monitoring a marine traffic, which includes a navigation data collection unit, a sectional navigation data generating unit, a learned data generating unit and a standard navigation data model calculation unit. The navigation data collection unit is configured to collect navigation data including a ship-related information of a plurality of ships sailing over an area to be monitored. The sectional navigation data generating unit is configured to generate sectional navigation data by classifying the navigation data for each of navigation sections based on the ship-related information. The learned data generating unit is configured to learn a sectional ship-related information included in the sectional navigation data, and to generate learned data. The standard navigation data model calculation unit is configured to calculate standard navigation data models for respective navigation sections by using the learned data.

In accordance with another embodiment, the present disclosure provides a method of monitoring a marine traffic, including collecting navigation data including a ship-related information of a plurality of ships sailing over an area to be monitored, and generating sectional navigation data by classifying the navigation data for each of navigation sections based on the ship-related information, and learning a sectional ship-related information included in the sectional navigation data and generating learned data, and calculating standard navigation data models for respective navigation sections by using the learned data.

### BRIEF DESCRIPTION OF THE DRAWINGS

FIG. 1 is a schematic block diagram of a marine traffic monitoring apparatus according to at least one embodiment of the present disclosure.

FIG. 2 is an exemplary diagram of a standard navigation data model according to at least one embodiment of the present disclosure.

FIG. 3A and FIG. 3B are a flowchart of a method, performed by a marine traffic monitoring apparatus, of determining whether or not a ship to be monitored exhibits an irregular navigation, according to at least one embodiment of the present disclosure.

FIG. 4 is an illustrative diagram of a method, performed by a marine traffic monitoring apparatus, of determining whether or not a ship to be monitored exhibits navigational irregularities, according to at least one embodiment of the present disclosure.

FIG. 5 is a flowchart of a method, performed by a marine traffic monitoring apparatus, of predicting the location of a ship to be monitored, according to at least one embodiment of the present disclosure.

FIG. 6 is an illustrative diagram of a method, performed by a marine traffic monitoring apparatus, of predicting the location of a ship to be monitored, according to at least one embodiment of the present disclosure.

FIG. 7 is a flowchart of a method, performed by a marine traffic monitoring apparatus, of judging whether or not an emergency situation occurs in a ship to be monitored, according to at least one embodiment of the present disclosure.

FIG. 8 is an illustrative diagram of a method, performed by a marine traffic monitoring apparatus, of judging whether or not an emergency situation occurs in a ship to be monitored, according to at least one embodiment of the present disclosure.

### REFERENCE NUMERALS

100: Marine traffic monitoring apparatus
110: Navigation data collection unit
120: Sectional navigation data generating unit
130: Learned data generating unit
140: Standard navigation data model calculation unit
150: Navigation state monitoring unit
152: Deviation discrimination unit
154: Location prediction unit
156: emergency situation judgment unit
160: input unit

### DETAILED DESCRIPTION

The present disclosure seeks to provide a method and an apparatus for monitoring a marine traffic, which learn navigation data of a plurality of ships sailing over an area to be monitored to calculate standard navigation data models for respective navigation sections, and monitor the state of navigation of the ship to be monitored based on the calculated standard navigation data models, and thereby provide an accurate and objective marine traffic monitoring.

Exemplary embodiments of the present disclosure are described below with reference to the accompanying drawings. In the following description, like reference numerals would rather designate like elements, although the elements are shown in different drawings. Further, in the following description of the at least one embodiment, a detailed description of known functions and configurations incorporated herein will be omitted for the purpose of clarity and for brevity.

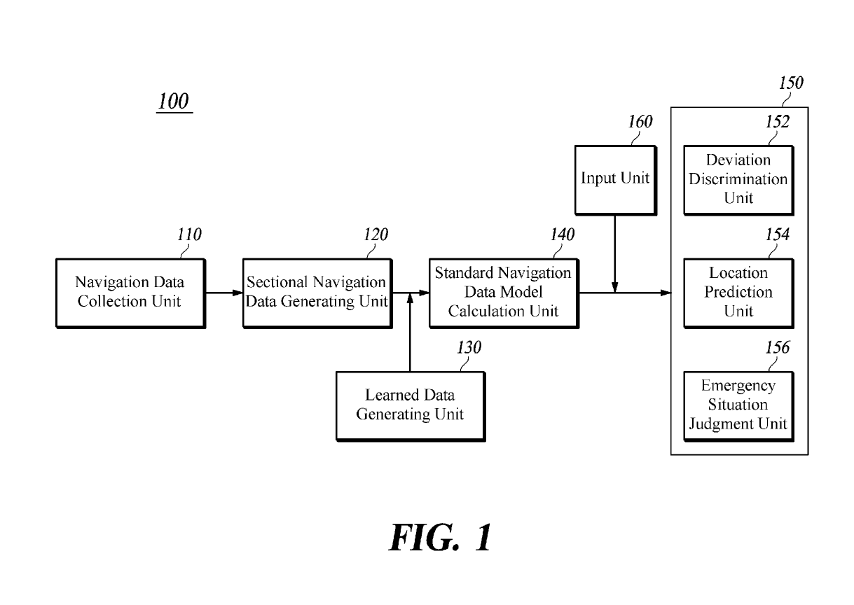

FIG. 1 is a schematic block diagram of a marine traffic monitoring apparatus according to at least one embodiment of the present disclosure.

A marine traffic monitoring apparatus 100 includes a navigation data collection unit 110, a sectional navigation data generating unit 120, a learned data generating unit 130, a standard navigation data model calculation unit 140, a navigation state monitoring unit 150 and an input unit 160.

The navigation data collection unit 110 performs a function of collecting navigation data of ships. The navigation data collection unit 110 periodically receives navigation data including ship-related information from ships equipped with an automatic identification system (AIS).

The navigation data collection unit 110 has constituent elements such as a radar, AIS, and GPS device for collecting navigation data of the ships.

The navigation data collection unit 110 according to some embodiments of the present disclosure collects navigation data including ship-related information from a plurality of ships navigating an area to be monitored. The ship-related information contained in the navigation data may include specification information and navigation information of the ships. The specification information of a ship may include the type and size of the ship. The navigation information may include ship's location, speed and course information. On the other hand, the moving speed of the ship is measured in units of knots. The direction of travel is measured in units of azimuth, and distance is measured in nautical mile, but they are not necessarily measured in this way.

The sectional navigation data generating unit 120 classifies the collected navigation data by navigation section and generates sectional navigation data.

The sectional navigation data generating unit 120 confirms the navigation start point and the navigation end point for each of the plurality of ships based on the ship-related information included in the collected navigation data.

The sectional navigation data generating unit 120 calculates navigation section information for each of the plurality of ships based on the confirmation result of the ship's navigation start point and the navigation end point. Various navigation sections may be calculated based on setting information such as an entry region of the route, an exit region of the route, an anchorage region, a berthing region, and the like. In the present embodiment, the navigation section is not limited to a specific section.

In some embodiments, the navigation section information of each of the plurality of ships is included in the navigation data of the ship collected by using the navigation data collection unit 110.

The sectional navigation data generating unit 120 classifies navigation data of ships sharing the same navigation section among the plurality of ships into the same group and generates sectional navigation data.

The learned data generating unit 130 learns sectional ship-related information included in the sectional navigation data to generate learned data. Hereinafter, the present embodiment illustrates that the learned data generating unit 130 learns the sectional ship-related information included in the sectional navigation data based on a machine learning algorithm, but this is not necessarily the case.

The standard navigation data model calculation unit 140 calculates a standard navigation data model for the respective navigation sections by using the learned data. The standard navigation data model refers to the representative navigation data model that objectively defines navigation data for ships navigating their respective navigation sections.

The standard navigation data model includes some or all of an extracted track model, an extracted speed change model and a course change model. The extracted track model is one that defines standard travel routes of the ships navigating the respective navigation sections. The extracted speed change model is one that defines standard speed information of the ships navigating the respective navigation sections. The course change model is a model that defines standard navigation direction information of the ships navigating the respective navigation sections.

The standard navigation data model calculation unit 140 utilizes the learned data generated by the learned data generating unit 130 so as to generate, for the respective navigation sections, a plurality of candidate navigation data models defining pattern information of at least one of travel routes, speed changes and course changes of the ships navigating the navigation sections.

The standard navigation data model calculation unit 140 selects a candidate navigation data model whose validation error is the minimum among the plurality of candidate navigation data models, and it calculates the selected candidate navigation data model as the standard navigation data model.

The following describes a method of calculating a standard navigation data model by the standard navigation data model calculation unit 140 assuming that navigation data of N ships exist for a specific navigation section (L).

The standard navigation data model calculation unit 140 divides N-ship data equally by K (N and K are natural numbers).

The standard navigation data model calculation unit 140 utilizes K−1 ship navigation data groups of among K ship navigation data groups as learning data and utilizes the remaining single ship navigation data group as verification data for verification purpose. For example, assuming that hundred ship navigation data are equally divided by ten, ninety ship navigation data groups are used as learning data, and the remaining ten ship navigation data are used as verification data. The standard navigation data model calculation unit 140 repeats learning for the standard navigation data model calculation K times in accordance with the navigation data utilization method as described above.

The standard navigation data model calculation unit 140 calculates an average validation error value by averaging validation error values of the K candidate navigation data models obtained through learning.

The standard navigation data model calculation unit 140 selects, among the K candidate navigation data models, the candidate navigation data model whose validation error is closest to the average validation error, and it selects the selected candidate navigation data model as the standard navigation data model. The standard navigation data model is a model representing the navigation data of ships navigating a specific navigation section, and it is subsequently used as reference data in the process of monitoring the navigation state of the ships to be monitored operating in the specific navigation section.

The navigation state monitoring unit 150 performs a function of monitoring the navigation state of the ships to be monitored. Here, the ship to be monitored refers to a ship selected by an administrator from among the ships sailing over the current monitored area as an object to be monitored.

The navigation state monitoring unit 150 obtains navigation data of the ship to be monitored. It is preferable, but not necessary, that the navigation data of the ship to be monitored is collected via the navigation data collection unit 110 and provided to the navigation state monitoring unit 150.

The navigation state monitoring unit 150 confirms the navigation section of the ship to be monitored based on the navigation data of the ship to be monitored. The navigation state monitoring unit 150 generates, among the standard navigation data models generated by the standard navigation data model calculation unit 140, the corresponding standard navigation data model that corresponds to the navigation section of the ship to be monitored (hereinafter explicitly referred to as the corresponding standard navigation data model).

The navigation state monitoring unit 150 monitors the navigation state of the ship to be monitored with the corresponding standard navigation data model applied to the obtained navigation data of the ship to be monitored. As the navigation state monitoring function against the ship to be monitored, the navigation state monitoring unit 150 may perform at least one of discriminating whether or not the ship to be monitored exhibits a deviation or navigational irregularity, predicting the location of the ship to be monitored, and determining whether or not an emergency situation occurs in the ship to be monitored.

The navigation state monitoring unit 150 includes a deviation discrimination unit 152, a location prediction unit 154 and an emergency situation judgement unit 156.

The deviation discrimination unit 152 performs a function of checking whether or not there is an irregular navigation or a deviation of the ship to be monitored.

The deviation discrimination unit 152 confirms the current location of the ship to be monitored based on the navigation data of the same ship. The deviation discrimination unit 152 calculates, on a standard travel route of the ship defined in the corresponding standard navigation data model, an approximate point having the smallest positional difference from the current location of the ship to be monitored.

The deviation discrimination unit 152 discriminates whether or not the ship to be monitored exhibits a deviation or navigational irregularity based on navigation data defined in the corresponding standard navigation data model for the approximate point and the navigation data of the ship to be monitored. In other words, the deviation discrimination unit 152 compares the location data, speed data and course data corresponding to the calculated approximate point with the location data, speed data and course data of the current ship to be monitored, and thereby confirms whether the ship to be monitored poses an irregular navigation.

In the present embodiment, the deviation discrimination unit 152 determines whether or not the value of the difference between the location data corresponding to the calculated approximate point and the current location data of the current ship to be monitored exceeds a preset reference value or criterion, and if yes, it classifies that ship to be monitored as a ship with positional irregularity. Similarly, the deviation discrimination unit 152 can classify the ship to be monitored as a ship with an irregular speed or an irregular course by using the same classification method. At this time, it is preferable that the criterion of the location data is set to 0.5 nautical miles, the criterion of the speed data is set to 2 knots, and the criterion of the course data is set to 10°, but the criteria are not necessarily limited thereto. For example, the criteria of the respective data may be determined with various numerical values according to the circumstances of the port, such as the width and length of the route and the density of marine traffic.

The location prediction unit 154 performs a function of predicting the location of the ship to be monitored immediately after a predetermined point in time has passed since the present time. The predetermined point in time is determined based on the input value of the location estimation time of the ship to be monitored.

The location prediction unit 154 calculate, on a standard travel route of the ship defined in the corresponding standard navigation data model, an approximate point having the smallest positional difference from a current location of the ship to be monitored. The method by which the location prediction unit 154 calculates the approximate point is the same as the aforementioned method in which the deviation discrimination unit 152 calculates the approximate point, and detailed description thereof is omitted here.

Based on the navigation data defined in the section between the calculated approximate point and the end point of the standard travel route, the location prediction unit 154 predicts the location of the ship to be monitored immediately after passing a predetermined point in time corresponding to the input value of the location estimation time since the present time.

In the present embodiment, the location prediction unit 154 predicts the location of the ship to be monitored by applying the values of changes of the location data, speed data, and course data defined in the section between the calculated approximate point and the end point of the standard travel route to the location data, speed data, and course data at the approximate point.

The emergency situation judgement unit 156 performs a function of judging whether or not an emergency situation occurs in the ship to be monitored.

The emergency situation judgement unit 156 calculates an approximate point having the smallest positional difference from the current location of the ship to be monitored on the standard travel route of the ship defined in the corresponding standard navigation data model.

The emergency situation judgement unit 156 extracts a nearing or approaching ship located within the preset range based on the calculated approximate point. Similarly, it calculates an approximate point for the approaching ship on the standard travel route. Here, designation of the range for searching an approaching ship is not limited to a specific range.

The emergency situation judgement unit 156 obtains the result of the navigational location prediction in the section between the respective approximate points calculated for the ship to be monitored and the approaching ship and the end point of the standard travel route. The emergency situation judgement unit 156 according to some embodiments collects the location prediction results of the ship to be monitored and the approaching ship via the location prediction unit 154. In another embodiment, the emergency situation judgement unit 156 obtains the location prediction results of the ship to be monitored and the approaching ship by using the same method as the aforementioned method for the location prediction unit 154 to predict the location of the ship to be monitored.

Based on the obtained location prediction result, the emergency situation judgement unit 156 calculates the closet point of approach (CPA) where the ship to be monitored has the smallest positional difference from the approaching ship in the remaining section. The emergency situation judgement unit 156 classifies the CPA as a potential collision spot if the positional difference between the ship to be monitored and the approaching ship at the CPA has a value less than a preset criterion.

When the potential collision spot is confirmed, the emergency situation judgement unit 156 confirms the expected arrival time (Time to CPA or TCPA) of the ship to be monitored and the approaching ship to the potential collision spot. The emergency situation judgement unit 156 classifies the relevant approaching ship as a high risk managed ship when the expected arrival time of the ship to be monitored and the approaching ship up to the potential collision spot has a value equal to or less than a predetermined criterion.

The emergency situation judgement unit 156 calculates and provides the numerical value of the collision risk of the high risk managed ship based on the expected arrival time of the high-risk managed ship up to the potential collision spot.

The input unit 160 receives various selection information and input information from the user. For example, the input unit 160 receives and relays selection information of the ship to be monitored from the user and an input value of a location estimation time of the ship to be monitored by using input means such as a touch screen and a keypad, to the navigation state monitoring unit 150.

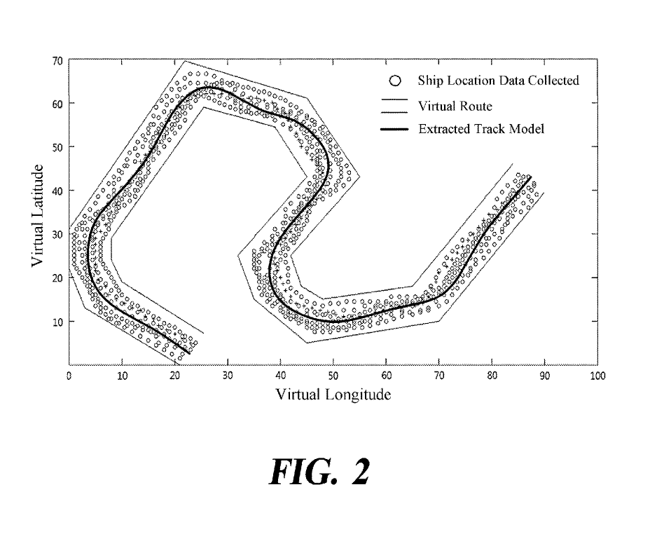

FIG. 2 is an exemplary diagram of a standard navigation data model according to at least one embodiment of the present disclosure.

The marine traffic monitoring apparatus 100 according to the present embodiment learns navigation data of a plurality of ships sailing over an area to be monitored to calculate standard navigation data model that is composed of some or all of an extracted track model, an extracted speed change model and a course change model. FIG. 2 illustrates an extracted track model among a plurality of standard models included in the standard navigation data model.

As shown in FIG. 2, the extracted track model according to the present embodiment defines a standard travel route for ships sailing a specific navigation section. Such extracted track model is used as reference data in the course of monitoring the navigation state of the ships to be monitored operating in a specific navigation section.

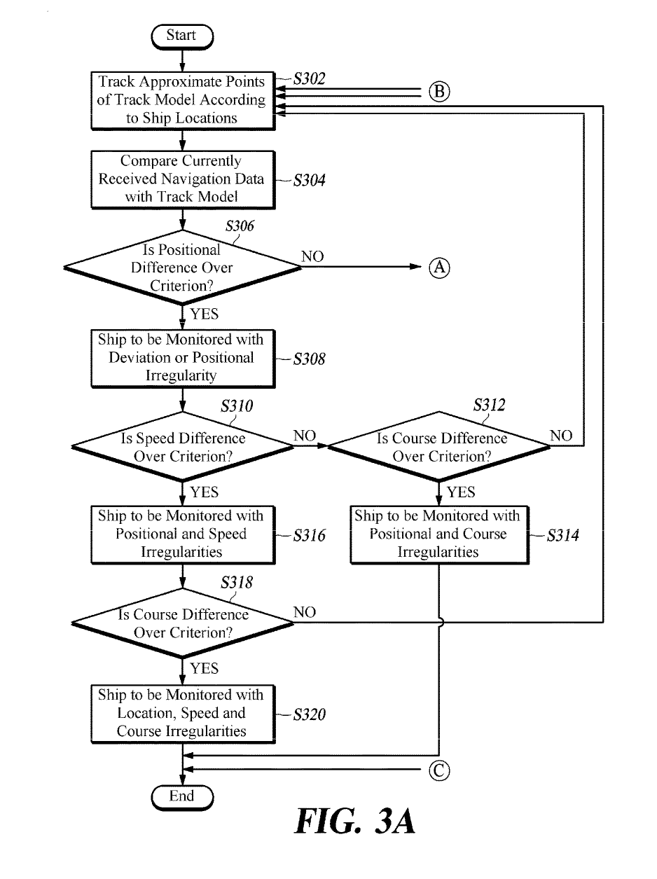

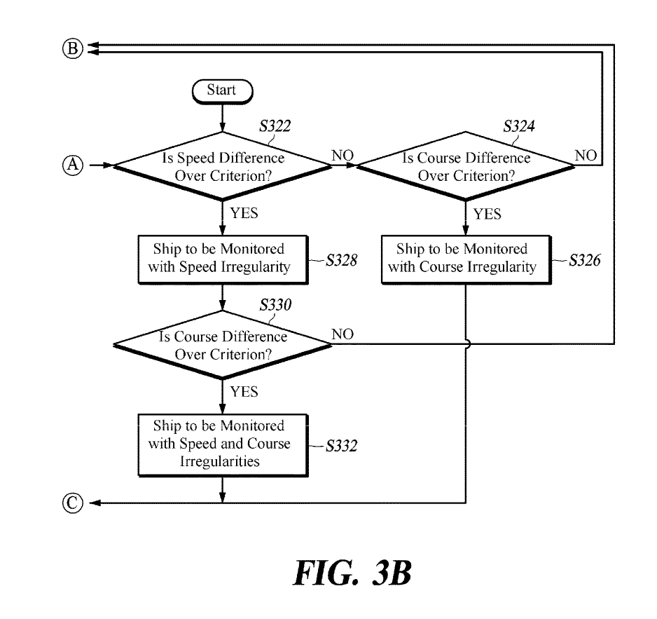

FIG. 3A and FIG. 3B are a flowchart of a method, performed by a marine traffic monitoring apparatus, of determining whether or not a ship to be monitored exhibits an irregular navigation, according to at least one embodiment of the present disclosure.

Based on the navigation data of the ship to be monitored, the marine traffic monitoring apparatus 100 calculates an approximate point having the smallest positional difference from the current location of the ship to be monitored on the standard travel route of the ship defined within the corresponding standard navigation data model (Step S302).

With respect to the approximate point calculated in Step S302, the marine traffic monitoring apparatus 100 compares navigation data defined in the corresponding standard navigation data model with the current navigation data of the ship to be monitored (S304). In Step S304, the marine traffic monitoring apparatus 100 compares the location data, speed data and course data corresponding to the calculated approximate point calculated in Step S302 with the location data, speed data and course data of the current ship to be monitored.

The marine traffic monitoring apparatus 100 is responsive to when the value of the difference between the location data corresponding to the approximate point and the location data of the current ship to be monitored exceeds a preset criterion (S306), for classifying the ship to be monitored as having a positional irregularity (S308).

With respect to the monitored ship classified as having a positional irregularity, the marine traffic monitoring apparatus 100 utilizes the same classification method as the one performed in Step S306 for additionally judging the ships's deviation and irregular changes in navigation data of at least one of speed and course thereof (S310 to S320).

When Step S306 confirms that there is no abnormality in the location data of the ship to be monitored, the marine traffic monitoring apparatus 100 judges whether or not there is an irregularity in the navigation data of at least one of the speed and the course of the vessel to be monitored (S322 to S332).

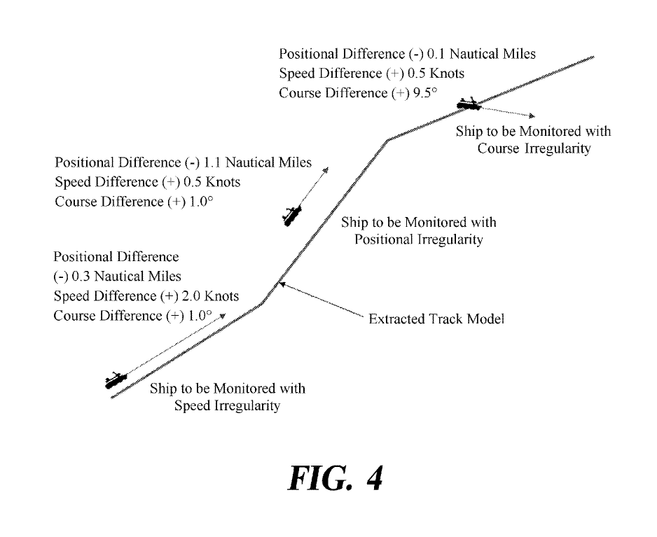

FIG. 4 is an illustrative diagram of a method, performed by a marine traffic monitoring apparatus, of determining whether or not a ship to be monitored exhibits navigational irregularities, according to at least one embodiment of the present disclosure.

As shown in FIG. 4, the marine traffic monitoring apparatus 100 monitors the state of navigation of the ship to monitor by comparing navigation data defined for the approximate point of the ship to monitor, calculated on the standard travel route with the current navigation data of the ship to monitor.

Referring to FIG. 4, when the positional difference of the ship to monitor is a negative value, one can confirm that the ship is positioned on the portside from the standard travel route by the negative value. When the positional difference of the ship to monitor is positive, one can confirm that the ship is positioned on the starboard side from the standard travel route by the positive value.

In addition, it can be confirmed that a negative value of the speed difference of the ship to monitor exhibits a correspondingly lower speed of the ship than the standard speed. When the speed difference of the ship to monitor is positive, the speed of the ship can be confirmed to be faster than the standard speed by the positive value.

In addition, when the course difference of the ship to monitor is a negative value, it can be confirmed that the course of the ship is more toward the portside than the standard course by the negative value. If the course difference of the ship to monitor is positive, it can be confirmed that the course of the ship is more to the starboard side than the standard course by the positive value.

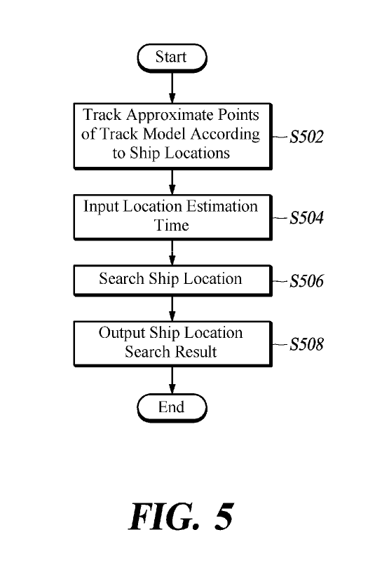

FIG. 5 is a flowchart of a method, performed by a marine traffic monitoring apparatus, of predicting the location of a ship to be monitored, according to at least one embodiment of the present disclosure.

Based on the navigation data of the ship to be monitored, the marine traffic monitoring apparatus 100 calculate, on the standard travel route of the ship defined in the corresponding standard navigation data model, an approximate point having the smallest positional difference from the current location of the ship to be monitored (S502).

The marine traffic monitoring apparatus 100 receives the input value of the location estimation time of the ship to be monitored (S504).

Based on the navigation data defined in the section between the calculated approximate point from Step S502 and the end point of the standard travel route, the marine traffic monitoring apparatus 100 predicts the location of the ship to be monitored immediately after passing a predetermined point in time corresponding to the input value of the location estimation time since the present time (S506). In Step S506, the marine traffic monitoring apparatus 100 predicts the location of the ship to be monitored by applying the values of changes of the location data, speed data, and course data defined in the section between the calculated approximate point and the end point of the standard travel route to the location data, speed data, and course data at the approximate point.

The marine traffic monitoring apparatus 100 outputs the location of the ship to be monitored predicted in step S506 in a form that the user can perceive (S508).

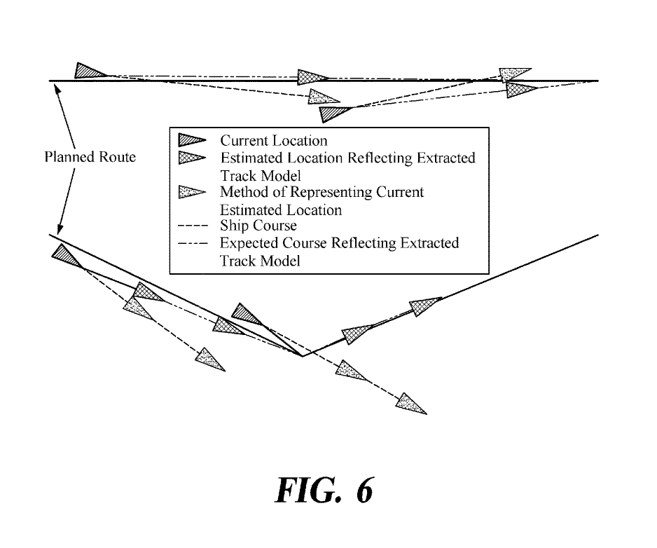

FIG. 6 is an illustrative diagram of a method, performed by a marine traffic monitoring apparatus, of predicting the location of a ship to be monitored, according to at least one embodiment of the present disclosure.

Referring to FIG. 6, it can be confirmed that the marine traffic monitoring apparatus 100 predicts the location of the ship to be monitored by applying the values of changes of the location data, speed data, and course data defined in the section between the calculated approximate point of the ship to be monitored and the end point of the standard travel route to the location data, speed data, and course data at the approximate point.

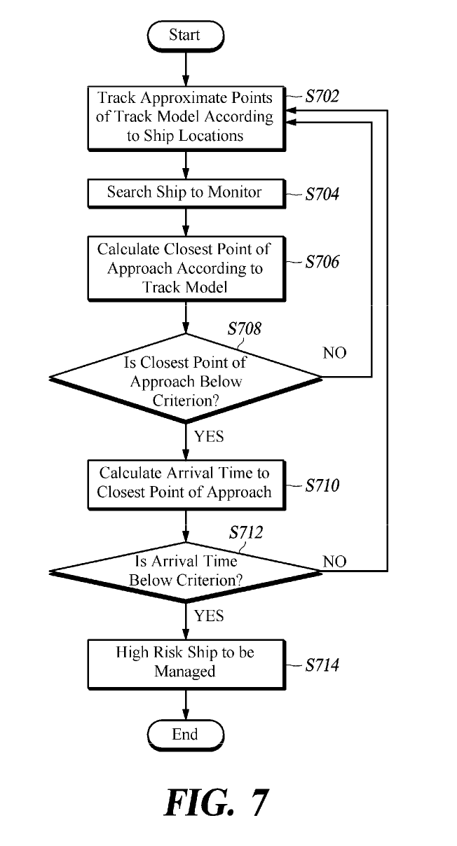

FIG. 7 is a flowchart for explaining a method of judging whether or not an emergency situation occurs in a ship to be monitored in the marine traffic monitoring apparatus of the ship according to the present embodiment.

Based on the navigation data of the ship to be monitored, the marine traffic monitoring apparatus 100 calculates an approximate point having the smallest positional difference from the current location of the ship to be monitored on the standard travel route of the ship defined in the corresponding standard navigation data model (S702).

The marine traffic monitoring apparatus 100 extracts an approaching ship located within a preset range with reference to the approximate point calculated in Step S702 (S704). In Step S704, based on the navigation data of the approaching ship, the marine traffic monitoring apparatus 100 calculates, on a standard travel route of the ship defined in the corresponding standard navigation data model, an approximate point having the smallest positional difference from the current location of the approaching ship.

The marine traffic monitoring apparatus 100 predicts the navigation location in the remaining navigation section for each of the ship to monitor and the approaching ship, and calculates, based on the prediction results, the marine traffic monitoring apparatus 100 calculates the closet point of approach (CPA) where the ship to be monitored has the smallest positional difference from the approaching ship in the remaining section (S706).

The marine traffic monitoring apparatus 100 classifies the CPA as a potential collision spot if the positional difference between the ship to be monitored and the approaching ship at the CPA has a value less than a preset criterion (S708).

When the potential collision spot is confirmed, the marine traffic monitoring apparatus 100 confirms the expected arrival time (TCPA) of the monitored ship and the approaching ship to the potential collision spot (S710).

The marine traffic monitoring apparatus 100 is responsive to when the expected arrival time confirmed in Step S710 has a value equal to or less than a predetermined criterion (S712), for classifying the relevant approaching ship as a high risk managed ship (S714).

The respective processes of the flowcharts shown in FIGS. 3A to 3B, 5 and 7 can be implemented as computer readable codes, and can be recorded on a non-transitory computer-readable medium. Further, the computer-readable recording medium can be distributed in computer systems connected via a network, and computer-readable codes can be stored and executed in a distributed mode.

A marine traffic monitoring apparatus 100 according to at least one embodiment of the present disclosure may correspond to various apparatuses each including (a) a communication apparatus such as a communication modem and the like for performing communications with various types of devices or a wired/wireless communication networks, (b) a memory for storing various programs and data, and (c) a microprocessor for executing a program so as to perform calculation and controlling, and the like. According to at least one embodiment, the memory includes a computer-readable recording/storage medium such as a random access memory (RAM), a read only memory (ROM), a flash memory, an optical disk, a magnetic disk, a solid-state disk (SSD), and the like. According to at least one embodiment, the microprocessor is programmed for performing one or more of operations and/or functions described herein. According to at least one embodiment, the microprocessor is implemented, in whole or in part, by specifically configured hardware (e.g., by one or more application specific integrated circuits or ASICs).

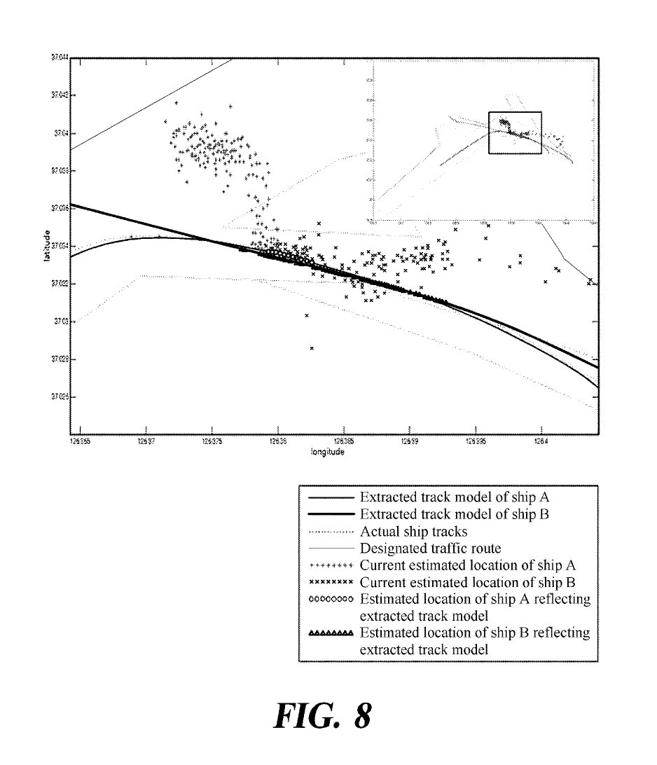

FIG. 8 is an illustrative diagram of a method, performed by a marine traffic monitoring apparatus, of judging whether or not an emergency situation occurs in a ship to be monitored, according to at least one embodiment of the present disclosure.

As shown in FIG. 8, the marine traffic monitoring apparatus 100 shows real time accumulation results of searching positions of the ship to be monitored and the nearing ship and/or calculating the collision risk, while showing the transition of changes thereof to thereby enable the administrator to confirm whether or not an emergency situation occurs in the ship to be monitored.

At least one of the components, elements, modules or units represented by a block as illustrated in FIG. 1 may be embodied as various numbers of hardware, software and/or firmware structures that execute respective functions described above, according to an exemplary embodiment. For example, at least one of these components, elements, modules or units may use a direct circuit structure, such as a memory, a processor, a logic circuit, a look-up table, etc. that may execute the respective functions through controls of one or more microprocessors or other control apparatuses. Also, at least one of these components, elements, modules or units may be specifically embodied by a module, a program, or a part of code, which contains one or more executable instructions for performing specified logic functions, and executed by one or more microprocessors or other control apparatuses. Also, at least one of these components, elements, modules or units may further include or may be implemented by a processor such as a central processing unit (CPU) that performs the respective functions, a microprocessor, or the like. Two or more of these components, elements, modules or units may be combined into one single component, element, module or unit which performs all operations or functions of the combined two or more components, elements, modules or units. Also, at least part of functions of at least one of these components, elements, modules or units may be performed by another of these components, elements, modules or units. Further, although a bus is not illustrated in the above block diagrams, communication between the components, elements, modules or units may be performed through the bus. Functional aspects of the above exemplary embodiments may be implemented in algorithms that execute on one or more processors. Furthermore, the components, elements, modules or units represented by a block or processing steps may employ any number of related art techniques for electronics configuration, signal processing and/or control, data processing and the like.

The operations or steps of the methods or algorithms described above can be embodied as computer readable codes on a computer readable recording medium, or to be transmitted through a transmission medium. The computer readable recording medium is any data storage device that can store data which can be thereafter read by a computer system. Examples of the computer readable recording medium include read-only memory (ROM), random-access memory (RAM), compact disc (CD)-ROM, digital versatile disc (DVD), magnetic tape, floppy disk, and optical data storage device, not being limited thereto. The transmission medium can include carrier waves transmitted through the Internet or various types of communication channel. The computer readable recording medium can also be distributed over network coupled computer systems so that the computer readable code is stored and executed in a distributed fashion.

According to the present disclosure as described above, a method and an apparatus for monitoring a marine traffic are effective to learn navigation data of a plurality of ships sailing over an area to be monitored to calculate standard navigation data models for respective navigation sections, and monitor the state of navigation of the ship to be monitored based on the calculated standard navigation data models, and thereby provide an accurate and objective marine traffic monitoring.

In addition, the present disclosure in at least one embodiment predicts not only the current navigational state of the ship but also the future voyage state, and thereby minimizes the possibility of a potential marine accident and cope with accident risk appropriately.

Although exemplary embodiments of the present disclosure have been described for illustrative purposes, those skilled in the art will appreciate that various modifications, additions and substitutions are possible, without departing from the various characteristics of the disclosure. Therefore, exemplary embodiments of the present disclosure have been described for the sake of brevity and clarity. Accordingly, one of ordinary skill would understand the scope of the disclosure is not limited by the explicitly described above embodiments but by the claims and equivalents thereof.

What is claimed is:

1. An apparatus for monitoring a marine traffic, comprising at least one processor to implement:
a navigation data collection unit configured to collect navigation data including a ship-related information of a plurality of ships sailing over an area to be monitored;
a sectional navigation data generating unit configured to generate sectional navigation data by classifying the navigation data for each of navigation sections based on the ship-related information;
a learned data generating unit configured to
learn a sectional ship-related information included in the sectional navigation data, and
generate learned data; and
a standard navigation data model calculation unit configured to calculate standard navigation data models for respective navigation sections by using the learned data.

2. The apparatus of claim 1, wherein the processor further implements a navigation state monitoring unit configured to obtain navigation data of a ship to be monitored, and monitor a state of navigation of the ship to be monitored by applying the standard navigation data models to obtained navigation data.

3. The apparatus of claim 2, wherein the navigation state monitoring unit comprises a navigation monitoring module which comprises at least one of:
a deviation discrimination unit configured to discriminate whether or not the ship to be monitored exhibits a deviation;
a location prediction unit configured to predict a location of the ship to be monitored; and
an emergency situation judgement unit configured to determine whether or not an emergency situation occurs in the ship to be monitored,
wherein the navigation monitoring module monitors the state of navigation based on a corresponding standard navigation data model corresponding to a navigation section of the ship to be monitored among the standard navigation data models.

4. The apparatus of claim 3, wherein the deviation discrimination unit is configured to
calculate, on a standard travel route of the ship defined in the corresponding standard navigation data model, an approximate point having the smallest positional difference from a current location of the ship to be monitored, and
discriminate whether or not the ship to be monitored exhibits a deviation or navigational irregularity based on a defined navigation data for the approximate point and the navigation data of the ship to be monitored.

5. The apparatus of claim 3, wherein the location prediction unit is configured to
calculate, on a standard travel route of the ship defined in the corresponding standard navigation data model, an approximate point having the smallest positional difference from a current location of the ship to be monitored, and
calculate an estimated location of the ship to be monitored based on a defined navigation data for a navigation section spanning from the approximate point to an end point of the standard travel route and on an input value of a location estimation time of the ship to be monitored.

6. The apparatus of claim 3, wherein the emergency situation judgement unit is configured to
calculate, on a standard travel route of the ship defined in the corresponding standard navigation data model, an approximate point having the smallest positional difference from a current location of the ship to be monitored, and
determine whether or not there is a danger of collision between an approaching ship within a range preset with respect to the approximate point and the ship to be monitored.

7. The apparatus of claim 6, wherein the emergency situation judgement unit is configured to determine whether or not there is the danger of collision based on at least one of:
whether there is a potential collision spot having the smallest positional difference between the ship to be monitored and the approaching ship in a navigation section spanning between the approximate point and an end point of the standard travel route, and
an expected arrival time of the ship to be monitored and the approaching ship to the potential collision spot.

8. The apparatus of claim 1, wherein the navigation data collection unit is configured to collect ship specification information comprising types and sizes of the ships and ship navigation information comprising information on locations, speeds and courses of the ships, as the navigation data.

9. The apparatus of claim 1, wherein the sectional navigation data generating unit is configured to
confirm navigation start points and navigation end points of the plurality of ships and calculate navigation section information for each of the plurality of ships, and
generate the sectional navigation data by classifying navigation data of ships having an identical navigation section among the plurality of ships, into a common group.

10. The apparatus of claim 1, wherein the standard navigation data model calculation unit is configured to calculate the standard navigation data model comprising some or all of:
an extracted track model defining standard travel routes of the ships navigating the navigation sections based on the learned data;
an extracted speed change model defining standard speed information of the ships navigating the navigation sections; and
a course change model defining standard navigation direction information of the ships navigating the navigation sections.

11. The apparatus of claim 1, wherein the learned data generating unit is configured to learn the sectional ship-related information included in the sectional navigation data based on a machine learning algorithm.

12. The apparatus of claim 1, wherein the standard navigation data model calculation unit is configured to
generate a plurality of candidate navigation data models defining pattern information of at least one of travel routes, speed changes and course changes of the ships navigating the navigation sections based on the learned data, and
calculate a candidate navigation data model whose validation error is the minimum among the plurality of candidate navigation data models as the standard navigation data model.

13. A method of monitoring a marine traffic, comprising:
collecting navigation data including a ship-related information of a plurality of ships sailing over an area to be monitored;
generating sectional navigation data by classifying the navigation data for each of navigation sections based on the ship-related information;
learning a sectional ship-related information included in the sectional navigation data and generating learned data; and
calculating standard navigation data models for respective navigation sections by using the learned data.

14. The method of claim 13, further comprising:
obtaining navigation data of a ship to be monitored; and
monitoring a state of navigation of the ship to be monitored by applying the standard navigation data models to obtained navigation data.

15. The method of claim 14, wherein the monitoring of the state of navigation is performed based on the standard navigation data models and navigation data of the ship to be monitored and comprises at least one of:
discriminating whether or not the ship to be monitored exhibits a deviation or navigational irregularity;
predicting a location of the ship to be monitored; and
determining whether or not an emergency situation occurs in the ship to be monitored.
